(19) United States
(12) Patent Application Publication
(10) Pub. No.: US 2026/0036162 A1
(43) Pub. Date: Feb. 5, 2026

(54) BEARING DEVICE FOR VEHICLE WHEEL AND VEHICLE

(71) Applicant: NTN CORPORATION, Osaka (JP)

(72) Inventor: Akira TORII, Shizuoka (JP)

(21) Appl. No.: 19/099,613

(22) PCT Filed: Aug. 8, 2023
(86) PCT No.: PCT/JP2023/028925

§ 371 Date: Jan. 29, 2025

(30) Foreign Application Priority Data
Aug. 23, 2022 (JP) 2022-132693

(51) Int. Cl. F16C 19/18; F16D 3/223

(52) U.S. Cl. CPC F16C 19/186; F16D 3/223; F16C 2240/80; F16C 2326/02

(57) ABSTRACT

In a wheel bearing device (1): a ratio of an axial direction length C of a recessed portion (3h) formed in a through-hole (3e) of a hub ring (3) to a pitch circle diameter A of the recessed portion formed in an inner circumferential surface of the hub ring is 0.7≤(C/A)≤1.07; a ratio of an axial direction distance E between a flange surface (3j) of a wheel attachment flange (3b) and an inner end surface (4b) of an inner race (4) to an inter-ball pitch F between an inner ball row (5) and an outer ball row (6) is 2.85≤(E/F); and a ratio of the axial direction distance E to a pitch circle diameter D of balls (8) is 0.8≤(E/D) ≤0.94. The wheel bearing device makes it possible to suppress an increase in weight while suppressing generation of abnormal sounds.

### TECHNICAL FIELD

The present invention relates to a bearing device for a vehicle wheel and a vehicle.

### BACKGROUND ART

Conventionally, as disclosed in Patent Literature 1, a bearing device for a vehicle wheel including a bearing for a vehicle wheel that rotatably supports a vehicle wheel in a suspension of an automobile or the like and a constant velocity universal joint coupled to the bearing for a vehicle wheel so as to be capable of transmitting torque is known. In such a bearing device for a vehicle wheel, an outer joint member of the constant velocity universal joint is spline-fitted to an inner diameter portion of a hub ring constituting the bearing for a vehicle wheel, whereby the bearing for a vehicle wheel and the constant velocity universal joint are coupled.

The drive force from a drive source of a vehicle is input to the constant velocity universal joint. In recent years, in addition to vehicles using an engine as a drive source, electric vehicles using a motor as a drive source tend to increase.

Since the drive torque from the motor in the electric vehicle is instantaneously input to the constant velocity universal joint as compared with the drive torque from the engine, relative slip rapidly occurs between the inner ring of the bearing for a vehicle wheel and the abutment surface of the constant velocity universal joint with respect to the inner ring, and abnormal noise due to stick-slip, which is commonly referred to as squeaking noise or packing noise, may occur.

### CITATIONS LIST

### Patent Literature

Patent Literature 1: JP-B 3650746 Gazette

### SUMMARY OF INVENTION

### Technical Problems

To suppress the occurrence of abnormal noise due to slip between the bearing for a vehicle wheel and the constant velocity universal joint described above, grease is applied between the inner ring of the bearing for a vehicle wheel and the contact surface of the constant velocity universal joint with respect to the inner ring, a lubricant is coated on the contact surface of the constant velocity universal joint with respect to the inner ring, or a plate coated with a low-friction coating agent is sandwiched between the inner ring of the bearing for a vehicle wheel and the contact surface of the constant velocity universal joint with respect to the inner ring. However, it has been difficult to sufficiently suppress the occurrence of abnormal noise caused by the drive torque instantaneously applied from the motor.

To suppress the occurrence of abnormal noise due to slip between the bearing for a vehicle wheel and the constant velocity universal joint, it is also conceivable to increase the fitting diameter of spline fitting between the bearing for a vehicle wheel and the constant velocity universal joint according to the magnitude of the drive torque applied to the constant velocity universal joint. However, there is a problem that simply increasing the fitting diameter between the bearing for a vehicle wheel and the constant velocity universal joint results in an increase of the weight of the bearing for a vehicle wheel and the constant velocity universal joint.

The present invention has been made in view of the above circumstances. The present invention provides a bearing device for a vehicle wheel and a vehicle capable of suppressing weight increase while suppressing occurrence of abnormal noise.

### Solutions to Problems

That is, a bearing device for a vehicle wheel includes: a bearing for a vehicle wheel including an outer member, an inner member, and double-row rolling elements, the outer member including double-row outer raceway surfaces on an inner periphery, the inner member including a hub ring and at least one inner ring, the hub ring including a vehicle wheel mounting flange for mounting a vehicle wheel on one end portion in an axial direction, including a small-diameter step portion extending in the axial direction on an outer periphery, and including a through hole penetrating in the axial direction in an inner diameter portion, the at least one inner ring being press-fitted into the small-diameter step portion of the hub ring, the inner member including double-row inner raceway surfaces facing the double-row outer raceway surfaces, the double-row rolling elements being rollably accommodated between the outer raceway surfaces of the outer member and the inner raceway surfaces of the inner member; and a constant velocity universal joint including a fitting portion fittable to the through hole of the hub ring, wherein an inner peripheral surface of the through hole of the hub ring is formed with recesses extending along the axial direction, an outer peripheral surface of the fitting portion in the constant velocity universal joint is formed with protrusions extending along the axial direction and spline-fitted to the recesses, a ratio of an axial length C of the recesses to a pitch circle diameter A of the recesses satisfies 0.7≤(C/A)≤1.07, a ratio of an axial distance E between a flange surface of the vehicle wheel mounting flange and the other axial end surface of the inner ring to an inter-rolling element pitch F between a rolling element of the double-row rolling elements on one axial side and a rolling element of the double-row rolling elements on the other axial side in the double-row rolling elements satisfies 2.85≤(E/F), and a ratio of the axial distance E to a pitch circle diameter D of the double-row rolling elements satisfies 0.8≤(E/D)≤0.94.

### Advantageous Effects of Invention

The present invention can suppress weight increase while suppressing occurrence of abnormal noise.

### BRIEF DESCRIPTION OF DRAWINGS

FIG. 1 is a side sectional view illustrating a bearing device for a vehicle wheel.

FIG. 2 is a side sectional view illustrating a shaft hole of a hub ring and a stem portion of an outer joint member.

FIG. 3 is an axial sectional view illustrating recesses in the shaft hole of the hub ring and protrusions of the stem portion.

FIG. 4 is a side sectional view illustrating a bearing device for a vehicle wheel in a state where a shaft has pivoted by a maximum angle.

FIG. 5 is a side sectional view illustrating a bearing device for a vehicle wheel according to a second embodiment.

FIG. 6 is a side sectional view illustrating a bearing device for a vehicle wheel according to a third embodiment.

FIG. 7 is a side sectional view illustrating a bearing device for a vehicle wheel according to a fourth embodiment.

### DESCRIPTION OF EMBODIMENTS

Hereinafter, embodiments of the present invention will be described with reference to the accompanying drawings.

### Bearing Device for Vehicle Wheel

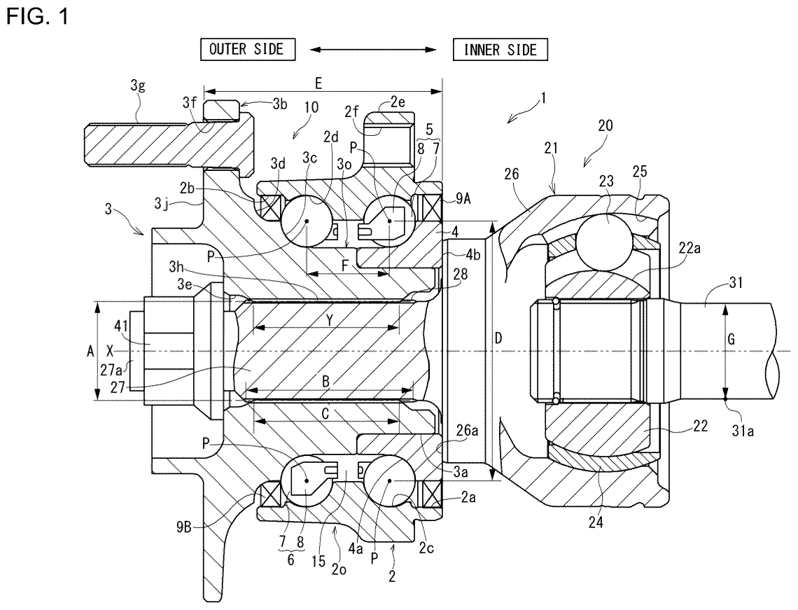

A bearing device for a vehicle wheel 1 illustrated in FIG. 1 is an embodiment of a bearing device for a vehicle wheel according to the present invention, including a bearing for a vehicle wheel 10 and a constant velocity universal joint 20.

In the following description, an axial direction refers to a direction along a rotation axis X of the bearing for a vehicle wheel 10. An outer side refers to one side in the axial direction and the vehicle wheel side of the bearing device for a vehicle wheel 1 when the bearing device for a vehicle wheel is attached to a vehicle body, and an inner side refers to the other side in the axial direction and the vehicle body side of the bearing device for a vehicle wheel 1 when the bearing device for a vehicle wheel is attached to a vehicle body.

### (Bearing for Vehicle Wheel)

The bearing for a vehicle wheel 10 rotatably supports a vehicle wheel in a suspension of a vehicle such as an automobile. The bearing for a vehicle wheel 10 includes an outer ring 2 that is an outer member, a hub ring 3 and an inner ring 4 that are inner members, two rows of an inner-side ball row 5 and an outer-side ball row 6 that are rolling rows, an inner-side seal member 9A, and an outer-side seal member 9B.

An inner-side end portion of the outer ring 2 is formed with an inner-side opening 2a into which the inner-side seal member 9A can be fitted. An outer-side end portion of the outer ring 2 is formed with an outer-side opening 2b into which the outer-side seal member 9B can be fitted.

An opening end on the inner side of an annular space 15 formed by the outer ring 2 and the inner member is closed by the inner-side sealing member 9A fitted into the inner-side opening 2a. An opening end on the outer side of the annular space 15 is closed by the outer-side sealing member 9B fitted into the outer-side opening 2b.

The inner peripheral surface of the outer ring 2 is formed with an outer raceway surface 2c on the inner side and an outer raceway surface 2d on the outer side. An outer peripheral surface 20 of the outer ring 2 is integrally formed with a vehicle body mounting flange 2e for mounting the outer ring 2 to a vehicle-body-side member (knuckle). The vehicle body mounting flange 2e is provided with a bolt hole 2f through which a fastening member for fastening the vehicle-body-side member and the outer ring 2 is to be inserted.

At an inner-side end portion of the outer peripheral surface 30 of the hub ring 3, a small-diameter step portion 3a that is reduced in diameter from the outer-side end portion and extends in the axial direction is formed. An outer-side end portion of the hub ring 3 is integrally formed with a vehicle wheel mounting flange 3b for mounting a vehicle wheel. The vehicle wheel mounting flange 3b is provided with a bolt hole 3f into which a hub bolt 3g is to be press-fitted.

The vehicle wheel mounting flange 3b has a flange surface 3j on which a brake rotor to be assembled to the vehicle wheel mounting flange 3b abuts. The flange surface 3j is a surface on the outer side of the vehicle wheel mounting flange 3b.

The hub ring 3 is formed with an inner raceway surface 3c on the outer side so as to face the outer raceway surface 2d on the outer side of the outer ring 2. In the hub ring 3, a lip sliding surface 3d on which the outer-side seal member 9B is in sliding contact is formed on a base side of the vehicle wheel mounting flange 3b.

An inner diameter portion of the hub ring 3 is formed with a shaft hole 3e formed along the axial direction and to which the constant velocity universal joint 20 is coupled. The shaft hole 3e penetrates the hub ring 3 in the axial direction. The shaft hole 3e is an example of a through hole. The inner ring 4 is press-fitted into the small-diameter step portion 3a of the hub ring 3. The inner ring 4 has an inner-side end surface 4b at the inner-side end portion. The inner-side end surface 4b is an example of the other axial end side surface of the inner ring.

An outer peripheral surface of the inner ring 4 is formed with an inner raceway surface 4a. That is, the inner ring 4 forms the inner raceway surface 4a on the inner side of the hub ring 3. The inner raceway surface 4a faces the outer raceway surface 2c on the inner side of the outer ring 2.

The inner-side ball row 5 and the outer-side ball row 6, which are rolling rows, are configured by a plurality of balls 7, which are rolling elements, held by a cage 8. The inner-side ball row 5 is rollably sandwiched between the inner raceway surface 4a of the inner ring 4 and the outer raceway surface 2c on the inner side of the outer ring 2. The outer-side ball row 6 is rollably sandwiched between the inner raceway surface 3c of the hub ring 3 and the outer raceway surface 2d on the outer side of the outer ring 2. The inner ring 4 applies a preload to the inner-side ball row 5 and the outer-side ball row 6 which are rolling rows.

The outer ring 2, the hub ring 3 and the inner ring 4, the inner-side ball row 5, and the outer-side ball row 6 constitute a double row angular ball bearing in the bearing for a vehicle wheel 10. The bearing for a vehicle wheel 10 may be a double row tapered roller bearing.

### (Constant Velocity Universal Joint)

The constant velocity universal joint 20 includes an outer joint member 21 in which a track groove 25 is formed on the inner peripheral surface, an inner joint member 22 in which a track groove 22a facing the track groove 25 is formed on the outer peripheral surface, a ball 23 incorporated between the track groove 25 and the track groove 22a, and a cage 24 interposed between the inner peripheral surface of the outer joint member 21 and the outer peripheral surface of the inner joint member 22 to hold the ball 23.

The outer joint member 21 includes a mouth portion 26 that accommodates internal components including the inner joint member 22, the ball 23, and the cage 24, and a stem portion 27 that integrally extends from the mouth portion 26 toward the outer side in the axial direction. The mouth portion 26 has an abutment surface 26a abutting on the inner-side end surface 4b of the inner ring 4 at the outer-side end portion.

An axial end of the shaft 31 to which a drive force from a drive source such as an engine or a motor is to be input is press-fitted into the inner joint member 22. The inner joint member 22 and the shaft 31 are coupled so as to be able to transmit torque through spline fitting. The mouth portion 26 of the outer joint member 21 pivotablly supports the shaft 31 with respect to the rotation axis X via the inner joint member 22, the ball 23, and the cage 24.

### Fitting Structure Between Hub Ring and Stem Portion

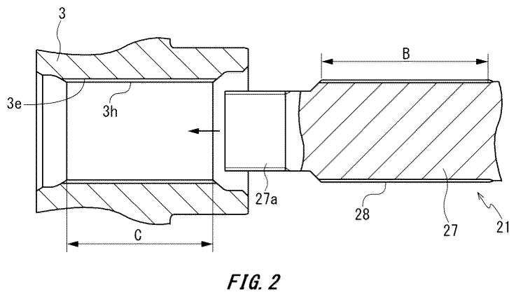

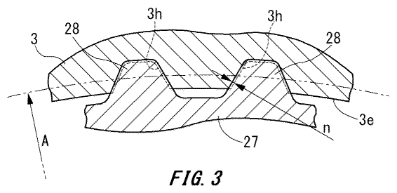

As illustrated in FIGS. 2 and 3, the inner peripheral surface of the shaft hole 3e of the hub ring 3 is formed with a recess 3h extending along the axial direction. A plurality of recesses 3h are formed along a circumferential direction. The outer peripheral surface of the stem portion 27 of the outer joint member 21 is formed with a protrusion 28 extending along the axial direction and spline-fitted to the recess 3h. A plurality of protrusions 28 are formed along the circumferential direction. The plurality of recesses 3h formed along the circumferential direction constitutes a female spline, and the plurality of protrusions 28 formed along the circumferential direction constitutes a male spline. The stem portion 27 of the outer joint member 21 is an example of a fitting portion that can be fitted into the through hole of the hub ring.

The recess 3h of the shaft hole 3e may be formed to have a smaller diameter than the protrusion 28 of the stem portion 27. In this case, the recess 3h has a fastening allowance n with respect to the protrusion 28, and the protrusion 28 is press-fitted.

The stem portion 27 has a male screw portion 27a on the outer side of the protrusion 28, and the hub ring 3 and the outer joint member 21 are fixed in a state where the stem portion 27 is fitted in the shaft hole 3e by screwing a nut 41 on the male screw portion 27a. Screwing the nut 41 on the male screw portion 27a can press the inner ring 4 in the axial direction at the abutment surface 26a of the outer joint member 21 and apply a preload to the inner-side ball row 5 and the outer-side ball row 6.

When the stem portion 27 is moved from the inner side to the outer side of the shaft hole 3e at the time of fitting the stem portion 27 into the shaft hole 3e, the protrusion 28 is press-fitted into the recess 3h because the recess 3h is formed to have a smaller diameter than the protrusion 28 and has the fastening allowance n for the protrusion 28.

When the protrusion 28 is press-fitted into the recess 3h, the inner peripheral surface of the recess 3h is extremely slightly cut by the protrusion 28, and the shape of the protrusion 28 is transferred to the inner peripheral surface of the recess 3h accompanying extremely slight plastic deformation and elastic deformation.

In a state where the protrusion 28 is press-fitted into the recess 3h, a fitting contact portion Y (see FIG. 1) between the spline-fitted recess 3h and protrusion 28 is formed. In the fitting contact portion Y, the outer peripheral surface of the protrusion 28 and the inner peripheral surface of the recess 3h are in close contact with each other as a whole.

In this manner, the recess 3h is spline-fitted to the protrusion 28 with the fastening allowance n, and the spline-fitted recess 3h and protrusion 28 are in close contact with each other as a whole in the axial direction. Since the protrusion 28 and the recess 3h are in close contact with each other as a whole at the fitting contact portion Y, the allowable torque at the fitting contact portion Y can be increased, and the axial length of the fitting contact portion Y can be shortened to reduce the weight of the bearing for a vehicle wheel 10.

### Relationship Between Dimensions of Each Portion in Bearing Device for Vehicle Wheel

In the bearing device for a vehicle wheel 1, the pitch circle diameter of the spline constituted by the recesses 3h and the protrusions 28 fitted to each other is A. The pitch circle diameter A of the spline is also the pitch circle diameter A of the recesses 3h and the pitch circle diameter A of the protrusions 28.

The axial length of the protrusions 28 in the stem portion 27 is B, and the axial length of the recesses 3h in the axial hole 3e is C. The axial distance between the flange surface 3j of the vehicle wheel mounting flange 3b and the inner-side end surface 4b of the inner ring 4 is E.

The pitch circle diameter of the balls 8 constituting the inner-side ball row 5 and the pitch circle diameter of the balls 8 constituting the outer-side ball row 6 are formed in the same size, and the pitch circle diameter of the balls 8 constituting the inner-side ball row 5 and the outer-side ball row 6 is D. The pitch circle diameter D is a diameter of a circle centered on the rotation axis X and passing through the centers P of the balls 8 in the inner-side ball rows 5 and 6. The pitch circle diameter D of the balls 8 is an example of a pitch circle diameter D of a rolling element.

The balls 8 constituting the inner-side ball row 5 and the balls 8 constituting the outer-side ball row 6 are disposed such that an inter-ball pitch is F in the axial direction. The inter-ball pitch F is a distance in the axial direction between the center P of the balls 8 in the inner-side ball row 5 and the center P of the balls 8 in the outer-side ball row 6. The inter-ball pitch F is an example of an inter-rolling element pitch F.

In the bearing device for a vehicle wheel 1, the ratio of the axial length C of the recesses 3h to the pitch circle diameter A of the recesses 3h is set such that 0.7≤(C/A)≤1.07 is satisfied.

In the conventional bearing device for a vehicle wheel, the ratio of the axial length B of the protrusions 28 to the pitch circle diameter A of the recesses 3h satisfies about 1.1≤(B/A)≤1.9, and the ratio of the axial length C of the recesses 3h to the pitch circle diameter A of the recesses 3h satisfies about 1.25≤(C/A)≤1.8.

On the other hand, in the bearing device for a vehicle wheel 1 in which the ratio of the axial length C of the recesses 3h to the pitch circle diameter A of the recesses 3h satisfies 0.7≤(C/A)≤1.07 as in the present embodiment, the diameters of the shaft hole 3e having the recesses 3h and the stem portion 27 having the protrusions 28 are formed larger, and the axial length C of the recesses 3h and the axial length B of the protrusions 28 are formed smaller than those of the conventional bearing device for a vehicle wheel.

The protrusions 28 of the stem portion 27 are twisted in the rotational direction when the drive torque is applied to the constant velocity universal joint 20, but the amount of twist of the protrusions 28 increases as the length of the stem portion 27 increases, and thus the amount of twist is proportional to the axial length B of the protrusions 28. The amount of twist of the protrusions 28 is inversely proportional to the pitch circle diameter A of the protrusions 28 since the torsional rigidity of the stem portion 27 increases as the diameter of the stem portion 27 increases.

When the drive torque is applied to the constant velocity universal joint 20, relative slip in the rotational direction occurs between the inner-side end surface 4b of the inner ring 4 in the bearing for a vehicle wheel 10 and the abutment surface 26a of the mouth portion 26 in the constant velocity universal joint 20. In this case, when the amount of twist of the protrusions 28 in the stem portion 27 decreases, the amount of relative slip between the inner-side end surface 4b of the inner ring 4 and the abutment surface 26a of the mouth portion 26 decreases.

Thus, by forming the diameter of the stem portion 27 to be large and forming the axial length C of the recesses 3h to be small, and setting the ratio of the axial length C of the recesses 3h to the pitch circle diameter A of the recesses 3h within the range of 0.7≤(C/A)≤1.07, the amount of relative slip between the inner-side end surface 4b and the abutment surface 26a of the mouth portion 26 can be reduced, and the occurrence of abnormal noise due to stick-slip can be suppressed.

Here, a twist angle of about 10 to 30 minutes with respect to the axial direction is normally applied to the protrusions 28 of the stem portion 27 to prevent rattling in spline-fitting the recesses 3h of the hub ring 3. Thus, in the conventional bearing device for a vehicle wheel, there is a portion having a gap between the spline-fitted protrusions 28 and recesses 3h. For example, when the surface on one side in the rotation direction at one axial end portion of the protrusion 28 is in contact with the recess 3h, there is a gap between the surface on one side in the rotation direction and the recess 3h at the other axial end portion of the protrusion 28. When the surface on the other side in the rotation direction at the other axial end portion of the protrusion 28 is in contact with the recess 3h, there is a gap between the surface on the other side in the rotation direction and the recess 3h at the one axial end portion of the protrusion 28.

Further, since the twisting direction of the protrusions 28 is unified in the same type of bearing device for a vehicle wheel 1, when the bearing device for a vehicle wheel 1 is used for left and right vehicle wheels in a vehicle, the twisting direction of the protrusions 28 and the direction of the drive torque to be applied to the stem portion 27 are different between the left and right vehicle wheels.

This causes the amount of relative slip in the rotation direction between the inner-side end surface 4b of the inner ring 4 and the abutment surface 26a of the mouth portion 26 when the drive torque is applied on the stem portion 27 to be greatly different between the left and right vehicle wheels, and the possibility that the abnormal noise due to the stick-slip occurs in the vehicle wheel on the side where the amount of slip is large increases.

However, in the bearing device for a vehicle wheel 1, the ratio of the axial length C of the recesses 3h to the pitch circle diameter A of the recesses 3h is set in the range of 0.7≤(C/A)≤1.07, and the amount of relative slip in the rotation direction between the inner-side end surface 4b and the abutment surface 26a of the mouth portion 26 is suppressed to be small. Thus, it is possible to suppress the occurrence of abnormal noise due to stick-slip even in a vehicle wheel having a large amount of slip.

In addition, when the diameter of the stem portion 27 is increased to form the pitch circle diameter A of the protrusions 28 large, the stress applied to the tooth surfaces of the protrusions 28 and the recesses 3h when the drive torque is applied to the stem portion 27 is reduced. Thus, the axial length B of the protrusions 28 and the axial length C of the recesses 3h can be formed small to reduce the axial length of the bearing for a vehicle wheel 10.

Thus, in the bearing device for a vehicle wheel 1, the inter-ball pitch F is formed small such that the ratio of an axial distance E between the flange surface 3j and the inner-side end surface 4b to the inter-ball pitch F satisfies 2.85≤(E/F), and the axial length of the bearing for a vehicle wheel 10 is reduced. The weight of the bearing for a vehicle wheel 10 can be reduced by reducing the axial length of the bearing for a vehicle wheel 10 in this manner.

In addition, in the bearing device for a vehicle wheel 1, the axial distance E is formed small such that the ratio of the axial distance E between the flange surface 3j and the inner-side end surface 4b to the pitch circle diameter D of the balls 8 satisfies 0.8≤(E/D)≤0.94, and the axial length of the bearing for a vehicle wheel 10 is reduced.

The weight of the bearing for a vehicle wheel 10 can be reduced by reducing the axial length of the bearing for a vehicle wheel 10 in this manner.

In this manner, in the bearing device for a vehicle wheel 1, weight increase can be suppressed while the occurrence of abnormal noise due to stick-slip is suppressed by setting the ratio of the axial length C of the recesses 3h to the pitch circle diameter A of the recesses 3h in the range of 0.7≤(C/A)≤1.07, setting the ratio of the axial distance E between the flange surface 3j and the inner-side end surface 4b to the inter-ball pitch F in the range of 2.85≤(E/F), and setting the ratio of the axial distance E between the flange surface 3j and the inner-side end surface 4b to the pitch circle diameter D of the balls 8 in the range of 0.8≤(E/D)≤0.94.

Further, in the bearing device for a vehicle wheel 1, the recesses 3h and the protrusions 28 spline-fitted to each other are spline-fitted in a state of having the fastening allowance n, and they are in close contact with each other as a whole in the axial direction. Thus, the bearing device for a vehicle wheel has an improved stress resistance against the drive torque to be applied to the stem portion 27 as compared with a case where the recesses and the protrusions are spline-fitted to each other in a state of not being in close contact with each other as a whole.

Thus, it is possible to reduce the axial length of the bearing for a vehicle wheel 10 by forming the axial length B of the protrusions 28 to be small such that the ratio of the axial length B of the protrusions 28 to the pitch circle diameter A of the recesses 3h satisfies 0.32≤(B/A)≤0.6. The weight of the bearing for a vehicle wheel 10 can be reduced by reducing the axial length of the bearing for a vehicle wheel 10 in this manner.

In the bearing device for a vehicle wheel 1, even when the spline-fitted recesses 3h and protrusions 28 are not in close contact with each other as a whole, weight increase can be suppressed while the occurrence of abnormal noise due to stick-slip is suppressed by setting the ratio of the axial length C of the recesses 3h to the pitch circle diameter A of the recesses 3h in the range of 0.7≤(C/A)≤1.07, setting the ratio of the axial distance E between the flange surface 3j and the inner-side end surface 4b to the inter-ball pitch F in the range of 2.85≤(E/F), and setting the ratio of the axial distance E between the flange surface 3j and the inner-side end surface 4b to the pitch circle diameter D of the ball 8 in the range of 0.8≤(E/D)≤0.94.

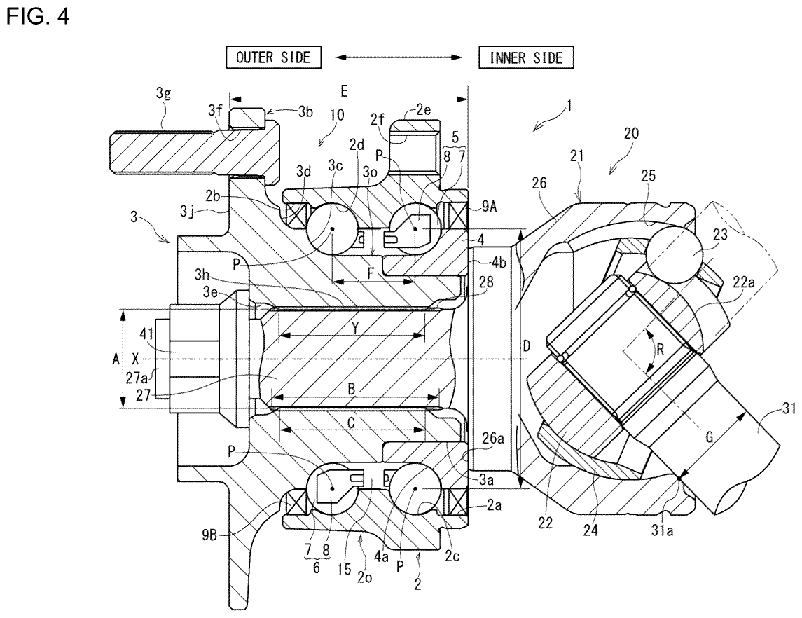

In the bearing device for a vehicle wheel 1, the shaft diameter of the shaft 31 in the constant velocity universal joint 20 is G. As illustrated in FIG. 4, the shaft 31 can pivot with respect to the mouth portion 26 within a range R in which the shaft 31 comes into contact with the mouth portion 26, and when the shaft 31 has pivoted by a maximum angle with respect to the mouth portion 26, a contact point 31a of the shaft 31 comes into contact with the mouth portion 26. The shaft diameter G is a shaft diameter of a portion including the contact point 31a of the shaft 31, and it is a minimum shaft diameter of the shaft 31.

The size of the stem portion 27 of the constant velocity universal joint 20 and the shaft diameter G of the shaft 31 are preferably determined according to the magnitude of the drive torque to be applied from the drive source such as a motor, but in the constant velocity universal joint 20 spline-fitted to the bearing for a vehicle wheel 10, the pitch circle diameter A of the protrusions 28 in the stem portion 27 and the shaft diameter G of the shaft 31 are set such that the ratio of the pitch circle diameter A of the protrusions 28 to the shaft diameter G satisfies 1.1≤(A/G)≤1.41.

This can secure the shaft diameter G of the shaft 31 required in the bearing device for a vehicle wheel 1, and it is possible to ensure a safety factor with respect to the drive torque to be applied on the constant velocity universal joint 20 and to ensure torsional rigidity of the shaft 31.

### Second Embodiment of Bearing Device for Vehicle Wheel

The bearing device for a vehicle wheel 1 can also be configured like a bearing device for a vehicle wheel 1A according to a second embodiment. As illustrated in

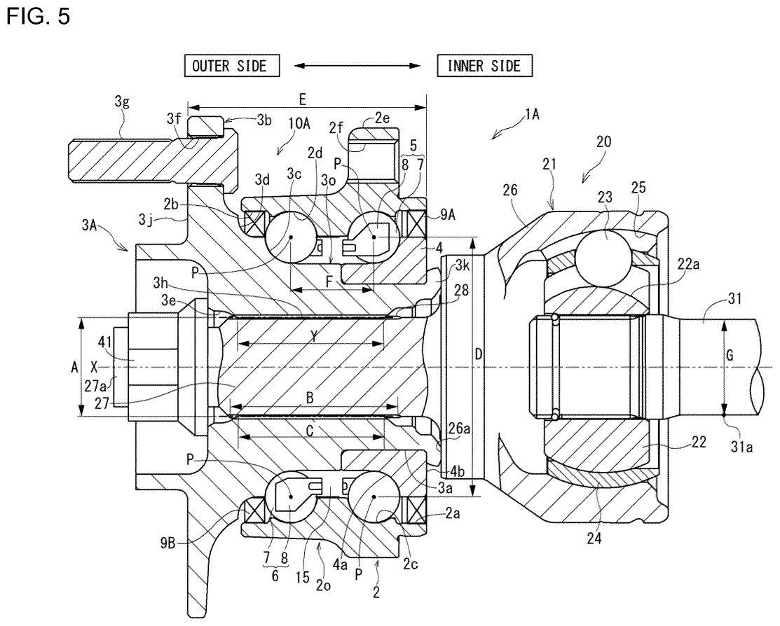

FIG. 5, the bearing device for a vehicle wheel 1A is different from the bearing device for a vehicle wheel 1 in that a bearing for a vehicle wheel 10A having a hub ring 3A is provided instead of the bearing for a vehicle wheel 10 having the hub ring 3.

In the bearing for a vehicle wheel 10A, the inner ring 4 press-fitted into the small-diameter step portion 3a of the hub ring 3A is fixed by being crimped by the hub ring 3A, and the hub ring 3A has a crimping portion 3k for crimping the inner-side end surface 4b of the inner ring 4. The inner ring 4 is crimped by the crimping portion 3k, whereby applying a preload on the inner-side ball row 5 and the outer-side ball row 6.

In the bearing for a vehicle wheel 10A, the crimping portion 3k of the hub ring 3A and the abutment surface 26a of the mouth portion 26 are in contact with each other. Since the other configurations of the bearing for a vehicle wheel 10A and the hub ring 3A are the same as those of the bearing for a vehicle wheel 10 and the hub ring 3, the same reference numerals are given, and the description thereof is omitted.

In the configuration in which the inner ring 4 is crimped by the crimping portion 3k as in the bearing for a vehicle wheel 10A, since a preload is applied by crimping the inner ring 4, it is not necessary to apply a preload by pressing the inner ring 4 with the axial force generated when the nut 41 is screwed to the male screw portion 27a of the stem portion 27.

Thus, it is not necessary to generate a large axial force when the nut 41 is screwed to the male screw portion 27a, and the abutment pressure between the crimping portion 3k of the hub ring 3A and the abutment surface 26a of the mouth portion 26 can be reduced. By reducing the abutment pressure between the crimping portion 3k and the abutment surface 26a, occurrence of stick-slip between the crimping portion 3k and the abutment surface 26a is suppressed, and occurrence of abnormal noise due to stick-slip can be suppressed.

In the bearing device for a vehicle wheel 1A as well, the ratio of the axial length C of the recesses 3h to the pitch circle diameter A of the recesses 3h can be set in the range of 0.7≤(C/A)≤1.07, the ratio of the axial distance E between the flange surface 3j and the inner-side end surface 4b to the inter-ball pitch F can be set in the range of 2.85≤(E/F), and the ratio of the axial distance E between the flange surface 3j and the inner-side end surface 4b to the pitch circle diameter D of the balls 8 can be set in the range of 0.8≤(E/D)≤0.94. This can suppress weight increase while further suppressing occurrence of abnormal noise due to stick-slip.

In the bearing device for a vehicle wheel 1A as well, the ratio of the axial length B of the protrusions 28 to the pitch circle diameter A of the recesses 3h can be set so as to satisfy 0.32≤(B/A)≤0.6. This can suppress an increase in weight of the bearing for a vehicle wheel 10 while suppressing occurrence of abnormal noise due to stick-slip.

Further, in the bearing device for a vehicle wheel 1A as well, the ratio of the pitch circle diameter A of the protrusions 28 to the shaft diameter G can be set so as to satisfy 1.1≤(A/G)≤1.41. This can ensure a safety factor with respect to the drive torque to be applied on the constant velocity universal joint 20 and to ensure the torsional rigidity of the shaft 31 while further suppressing occurrence of abnormal noise due to stick-slip in the bearing device for a vehicle wheel 1A.

### Third Embodiment of Bearing Device for Vehicle Wheel

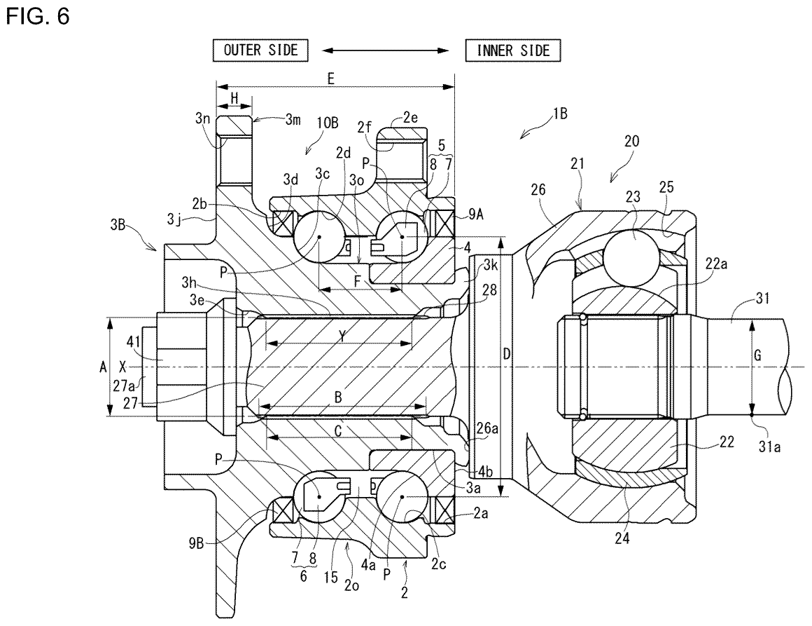

The bearing device for a vehicle wheel 1A can also be configured like a bearing device for a vehicle wheel 1B according to a third embodiment. As illustrated in FIG. 6, the bearing device for a vehicle wheel 1B is different from the bearing device for a vehicle wheel 1A in that a bearing for a vehicle wheel 10B having a hub ring 3B is provided instead of the bearing for a vehicle wheel 10A having the hub ring 3A.

The hub ring 3B is different from the hub ring 3A in that a vehicle wheel mounting flange 3m having a screw hole 3n is provided instead of the vehicle wheel mounting flange 3b having the bolt hole 3f. The screw hole 3n is a hole into which a wheel bolt for fixing a wheel and a brake rotor to be assembled to the vehicle wheel mounting flange 3m is to be screwed. The thickness of the vehicle wheel mounting flange 3m in the axial direction is H.

In the bearing for a vehicle wheel 10B, the hub ring 3B includes the vehicle wheel mounting flange 3m having the screw hole 3n into which the wheel bolt is to be screwed instead of the vehicle wheel mounting flange 3b having the bolt hole 3f into which the hub bolt 3g is to be press-fitted. Thus, the diameter of the outer ring 2 can be increased. With this configuration, when the axial length of the bearing for a vehicle wheel 10B is reduced, the outer diameter of the outer ring 2 can be increased to secure the longevity of the bearing for a vehicle wheel 10B.

Since the other configurations of the bearing for a vehicle wheel 10B and the hub ring 3B are the same as those of the bearing for a vehicle wheel 10A and the hub ring 3A, the same reference numerals are given, and the description thereof is omitted.

In the bearing device for a vehicle wheel 1B, the ratio of the axial distance E between the flange surface 3j and the inner-side end surface 4b to the thickness H of the vehicle wheel mounting flange 3m in the axial direction is set such that 4.5≤(E/H)≤5.6 is satisfied. With this setting, even when the axial distance E in the bearing device for a vehicle wheel 1B is set small, the thickness H of the vehicle wheel mounting flange 3m can be secured.

In the bearing device for a vehicle wheel 1B as well, the ratio of the axial length C of the recesses 3h to the pitch circle diameter A of the recesses 3h can be set in the range of 0.7≤(C/A)≤1.07, the ratio of the axial distance E between the flange surface 3j and the inner-side end surface 4b to the inter-ball pitch F can be set in the range of 2.85≤(E/F), and the ratio of the axial distance E between the flange surface 3j and the inner-side end surface 4b to the pitch circle diameter D of the balls 8 can be set in the range of 0.8≤(E/D)≤0.94. This can suppress weight increase while further suppressing occurrence of abnormal noise due to stick-slip.

In the bearing device for a vehicle wheel 1B as well, the ratio of the axial length B of the protrusions 28 to the pitch circle diameter A of the recesses 3h can be set so as to satisfy 0.32≤(B/A)≤0.6. This can suppress an increase in weight of the bearing for a vehicle wheel 10 while suppressing occurrence of abnormal noise due to stick-slip.

Further, in the bearing device for a vehicle wheel 1B as well, the ratio of the pitch circle diameter A of the protrusions 28 to the shaft diameter G can be set so as to satisfy 1.1≤(A/G)≤1.41. This can ensure a safety factor with respect to the drive torque to be applied on the constant velocity universal joint 20 and to ensure the torsional rigidity of the shaft 31 while further suppressing occurrence of abnormal noise due to stick-slip in the bearing device for a vehicle wheel 1B.

### Fourth Embodiment of Bearing Device for Vehicle Wheel

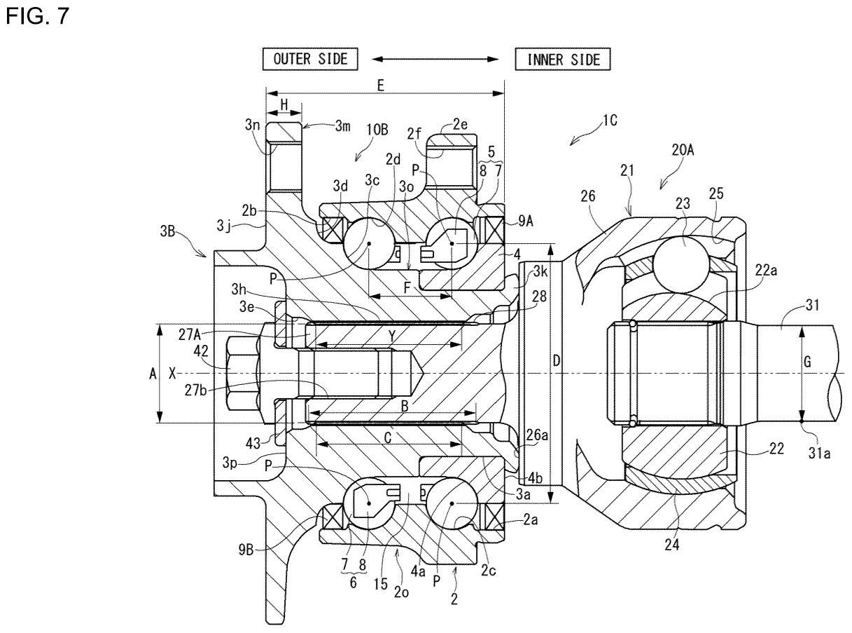

The bearing device for a vehicle wheel 1B can also be configured like a bearing device for a vehicle wheel 1C according to a fourth embodiment. As illustrated in FIG. 7, the bearing device for a vehicle wheel 1C is different from the bearing device for a vehicle wheel 1B in that a constant velocity universal joint 20A having a stem portion 27A is provided instead of the constant velocity universal joint 20 having the stem portion 27.

The stem portion 27A includes a female screw portion 27b formed from the outer-side surface toward the inner side, and the hub ring 3B and the constant velocity universal joint 20A are fastened in a state where the stem portion 27A is fitted in the shaft hole 3e by screwing a bolt 42 into the female screw portion 27b. This fixes the bearing for a vehicle wheel 10B and the constant velocity universal joint 20A.

A locking surface 3p, which is a surface perpendicular to the rotation axis X serving as the axis of the shaft hole 3e, is formed at the outer-side end portion of the shaft hole 3e of the hub ring 3B. In the present embodiment, the bolt 42 is locked to the locking surface 3p of the hub ring 3B via a washer 43, but the bolt 42 may be directly locked to the locking surface 3p without interposing the washer 43 as long as a necessary axial force can be obtained when the bolt 42 is screwed into the female screw portion 27b.

In the present embodiment, since the locking surface 3p is formed on a surface perpendicular to the axis of the shaft hole 3e, it is possible to obtain the axial force required when the bolt 42 is screwed into the female screw portion 27b, and it is possible to stably hold the fixed state between the bearing for a vehicle wheel 10B and the constant velocity universal joint 20A.

Since other configurations of the constant velocity universal joint 20A and the stem portion 27A are the same as those of the constant velocity universal joint 20 and the stem portion 27, the same reference numerals are given, and the description thereof is omitted.

In the bearing device for a vehicle wheel 1C, the ratio of the axial distance E between the flange surface 3j and the inner-side end surface 4b to the thickness H of the vehicle wheel mounting flange 3m in the axial direction is set such that 4.5≤(E/H)≤5.6 is satisfied. With this configuration, even when the axial distance E in the bearing device for a vehicle wheel 1C is set small, the thickness H of the vehicle wheel mounting flange 3m can be secured.

In the bearing device for a vehicle wheel 1C as well, the ratio of the axial length C of the recesses 3h to the pitch circle diameter A of the recesses 3h can be set in the range of 0.7≤(C/A)≤1.07, the ratio of the axial distance E between the flange surface 3j and the inner-side end surface 4b to the inter-ball pitch F can be set in the range of 2.85≤(E/F), and the ratio of the axial distance E between the flange surface 3j and the inner-side end surface 4b to the pitch circle diameter D of the balls 8 can be set in the range of 0.8≤(E/D)≤0.94. This can suppress weight increase while further suppressing occurrence of abnormal noise due to stick-slip.

In the bearing device for a vehicle wheel 1C as well, the ratio of the axial length B of the protrusions 28 to the pitch circle diameter A of the recesses 3h can be set so as to satisfy 0.32≤(B/A)≤0.6. This can suppress an increase in weight of the bearing for a vehicle wheel 10 while suppressing occurrence of abnormal noise due to stick-slip.

Further, in the bearing device for a vehicle wheel 1C as well, the ratio of the pitch circle diameter A of the protrusions 28 to the shaft diameter G can be set so as to satisfy 1.1≤(A/G)≤1.41. This can ensure a safety factor with respect to the drive torque to be applied on the constant velocity universal joint 20A and to ensure the torsional rigidity of the shaft 31 while further suppressing occurrence of abnormal noise due to stick-slip in the bearing device for a vehicle wheel 1C.

### Vehicle Including Bearing Device for Vehicle Wheel

The bearing device for a vehicle wheel 1, 1A, 1B, or 1C can be used for a vehicle using an engine, a motor, or the like as a drive source. In particular, using the bearing device for a vehicle wheel 1, 1A, 1B, or 1C in a vehicle in which a drive torque is instantaneously input to the constant velocity universal joint 20 or 20A, such as an electric vehicle using a motor as a drive source, makes it possible to effectively suppress occurrence of abnormal noise due to stick-slip while suppressing weight increase of the bearing device for a vehicle wheel 1, 1A, 1B, or 1C.

In addition, as in the bearing device for a vehicle wheel 1, 1A, 1B, or 1C, by forming the axial length of the bearing for a vehicle wheel 10, 10A, or 10B to be small, in the case of a front engine front drive (FF) vehicle for example, the swing center of the constant velocity universal joint 20 or 20A on the vehicle wheel side is moved to the vehicle wheel side more than in a conventional bearing device for a vehicle wheel, and it is possible to suppress the maximum angle of the constant velocity universal joint 20 or 20A at the time of steering and suppress an increase in the minimum rotation radius of the vehicle.

Although the embodiments of the present invention have been described above, the present invention is not limited to such embodiments in any way, and the embodiments are merely example. It is needless to say that the present invention can be implemented in various forms without departing from the gist of the present invention. The scope of the present invention is indicated by the description of the claims, and further includes the equivalent meaning and all changes within the scope of the claims.

### INDUSTRIAL APPLICABILITY

The present invention is applicable to a bearing device for a vehicle wheel.

### REFERENCE SIGNS LIST

1, 1A, 1B, 1C bearing device for vehicle wheel
2 outer ring
2c outer raceway surface (on inner side)
2d outer raceway surface (on outer side)
3, 3A, 3B hub ring
3a small-diameter step portion
3b, 3m vehicle wheel mounting flange
3c inner raceway surface
3e shaft hole
3h recess
3j flange surface
3k crimping portion
3n screw hole
4 inner ring
4a inner raceway surface
4b inner-side end surface
5 inner-side ball row
6 outer-side ball row
7 ball
8 cage
10, 10A, 10B bearing for vehicle wheel
20, 20A constant velocity universal joint
27 stem portion
28 protrusion
31 shaft
A pitch circle diameter
B axial length of protrusion
C axial length of recess
D pitch circle diameter of ball
E axial distance between flange surface and inner-side end surface of inner ring
F inter-ball pitch
G shaft diameter of shaft
H thickness of flange in axial direction
n fastening allowance

1-6. (canceled)

7. A bearing device for a vehicle wheel comprising:
a bearing for a vehicle wheel including an outer member, an inner member, and double-row rolling elements,
the outer member including double-row outer raceway surfaces on an inner periphery,
the inner member including a hub ring and at least one inner ring,
the hub ring including a vehicle wheel mounting flange for mounting a vehicle wheel on one end portion in an axial direction, including a small-diameter step portion extending in the axial direction on an outer periphery, and including a through hole penetrating in the axial direction in an inner diameter portion,
the at least one inner ring being press-fitted into the small-diameter step portion of the hub ring, the inner member including double-row inner raceway surfaces facing the double-row outer raceway surfaces,
the double-row rolling elements being rollably accommodated between the outer raceway surfaces of the outer member and the inner raceway surfaces of the inner member; and
a constant velocity universal joint including a fitting portion fittable to the through hole of the hub ring,
wherein an inner peripheral surface of the through hole of the hub ring is formed with recesses extending along the axial direction,
an outer peripheral surface of the fitting portion in the constant velocity universal joint is formed with protrusions extending along the axial direction and spline-fitted to the recesses,
a ratio of an axial length C of the recesses to a pitch circle diameter A of the recesses satisfies 0.7≤(C/A)≤1.07,
a ratio of an axial distance E between a flange surface of the vehicle wheel mounting flange and the other axial end surface of the inner ring to an inter-rolling element pitch F between a rolling element of the double-row rolling elements on one axial side and a rolling element of the double-row rolling elements on the other axial side in the double-row rolling elements satisfies 2.85≤(E/F), and
a ratio of the axial distance E to a pitch circle diameter D of the double-row rolling elements satisfies 0.8≤(E/D)≤0.94.

8. The bearing device for a vehicle wheel according to claim 7, wherein the hub ring includes a crimping portion for crimping the inner ring to the hub ring.

9. The bearing device for a vehicle wheel according to claim 7, wherein
the recesses and the protrusions that have been spline-fitted to each other are in close contact with each other as a whole in the axial direction, and
a ratio of an axial length B of the protrusions to the pitch circle diameter A of the recesses satisfies 0.32≤(B/A)≤0.6.

10. The bearing device for a vehicle wheel according to claim 7, wherein
the constant velocity universal joint includes a shaft to which a drive force is to be input, the shaft being coupled to the fitting portion and capable of transmitting torque, and
a ratio of the pitch diameter A of the protrusions to a shaft diameter G of the shaft satisfies 1.1≤(A/G)≤1.41.

11. The bearing device for a vehicle wheel according to claim 7, wherein
the vehicle wheel mounting flange includes a plurality of screw holes into which wheel bolts for fixing a wheel and a brake rotor are to be screwed, and
a ratio of the axial distance E to a thickness H of the vehicle wheel mounting flange in the axial direction satisfies 4.5≤(E/H)≤5.6.

12. A vehicle comprising:
the bearing device for a vehicle wheel according to claim 7; and
a motor that generates a drive force,
wherein the constant velocity universal joint includes a shaft to which the drive force from the motor is to be input, the shaft being coupled to the fitting portion and capable of transmitting torque.

13. A vehicle comprising:
the bearing device for a vehicle wheel according to claim 8; and
a motor that generates a drive force,
wherein the constant velocity universal joint includes a shaft to which the drive force from the motor is to be input, the shaft being coupled to the fitting portion and capable of transmitting torque.

14. A vehicle comprising:
the bearing device for a vehicle wheel according to claim 9; and
a motor that generates a drive force,
wherein the constant velocity universal joint includes a shaft to which the drive force from the motor is to be input, the shaft being coupled to the fitting portion and capable of transmitting torque.

15. A vehicle comprising:
the bearing device for a vehicle wheel according to claim 10; and
a motor that generates a drive force,
wherein the constant velocity universal joint includes a shaft to which the drive force from the motor is to be input, the shaft being coupled to the fitting portion and capable of transmitting torque.

16. A vehicle comprising:
the bearing device for a vehicle wheel according to claim 11; and
a motor that generates a drive force,
wherein the constant velocity universal joint includes a shaft to which the drive force from the motor is to be input, the shaft being coupled to the fitting portion and capable of transmitting torque.
